(19) United States
(12) Patent Application Publication
(10) Pub. No.: US 2024/0409048 A1
(43) Pub. Date: Dec. 12, 2024

(54) VEHICLE ACTIVE AIR SKIRT

(71) Applicant: HYUNDAI MOBIS CO., LTD., Seoul (KR)

(72) Inventors: Jae Sup BYUN, Yongin-si (KR); Jang Ho KIM, Yongin-si (KR)

(73) Assignee: HYUNDAI MOBIS CO., LTD., Seoul (KR)

(21) Appl. No.: 18/534,282

(22) Filed: Dec. 8, 2023

(30) Foreign Application Priority Data
Jun. 7, 2023 (KR) 10-2023-0072787

(51) Int. Cl. B60R 19/12; B60R 19/02

(52) U.S. Cl. CPC B60R 19/12; B60R 19/023; B60R 2019/247

(57) ABSTRACT

An embodiment of the present invention provides a vehicle active air skirt including a pair of guide frames including guide holes and installed inside a front bumper, a skirt connected to the guide holes inside the front bumper and supported by the guide frames, a first link of which one end is rotatably connected to a rear surface of the skirt, a second link of which one end is rotatably connected to the other end of the first link and the other end is connected to a vehicle body, and an actuator which rotates the second link, wherein the skirt is configured to reciprocate upwardly and downwardly along a trajectory provided by the guide holes as the second link rotates around the other end of the second link as a rotation shaft.

### CROSS-REFERENCE TO RELATED APPLICATION

This application claims priority to and the benefit of Korean Patent Application No. 10-2023-0072787, filed on Jun. 7, 2023, in the Korean Intellectual Property Office, the disclosure of which is incorporated herein by reference in its entirety for all purposes.

### BACKGROUND

### 1. Field of the Invention

The present invention relates to a vehicle active air skirt, and more specifically, to a vehicle active air skirt which reduces air resistance in lower front of a vehicle during traveling at high speed.

### 2. Discussion of Related Art

During traveling, a vehicle receives air resistance as a vehicle body collides with air in the atmosphere, and the air resistance causes a decrease in fuel efficiency.

Accordingly, the vehicle needs a structure to improve aerodynamic performance and fuel efficiency by reducing the air resistance.

An example of a device for improving the aerodynamic performance is an active air skirt which actively operates in conjunction with a vehicle speed, and the active air skirt uses a technology for improving the aerodynamic performance by reducing an amount of air flowing into an underbody through a front bumper during traveling at high speed.

However, in the conventional active air skirt, since there are too many components and an assembly structure is complex, there are problems that it is disadvantageous for securing assemblability and mass productivity and it is difficult to quickly operate to avoid an obstacle.

Accordingly, there is a need to solve the problems.

### SUMMARY OF THE INVENTION

The present invention is directed to providing a vehicle active air skirt with a structure which allows a reduction of the number of components and simplification of a connecting structure.

Objectives to be solved through the present invention are not limited to the above-described objectives, and other objectives which are not described above will be clearly understood to those skilled in the art from the following description.

According to an aspect of the present invention, there is a vehicle active air skirt including a pair of guide frames including guide holes and installed inside a front bumper, a skirt connected to the guide holes inside the front bumper and supported by the guide frames, a first link of which one end is rotatably connected to a rear surface of the skirt, a second link of which one end is rotatably connected to the other end of the first link and the other end is connected to a vehicle body, and an actuator which rotates the second link, wherein the skirt is configured to reciprocate upwardly and downwardly along a trajectory provided by the guide holes as the second link rotates around the other end of the second link as a rotation shaft.

The vehicle active air skirt may further include a loader which connects the actuator and the second link, wherein one end of the loader may be connected to a driving shaft of the actuator, and the other end of the loader may pass through and be connected to the second link to transmit power of the actuator to the second link.

The second link may include a connecting hole extending in a longitudinal direction, the other end of the loader may include a connecting protrusion to be inserted into the connecting hole, the loader may rotate around the driving shaft such that the connecting protrusion may slide along the connecting hole.

The one end of the second link may vertically reciprocate between the guide frames as the second link rotates around the other end of the second link as a rotation shaft in a state in which the connecting protrusion is engaged with the connecting hole.

A circumferential length of a circle drawn while the connecting protrusion rotates around the driving shaft may be two times a length of the connecting hole.

The second link may have a structure in which a length of the second link is greater than a length of the loader.

The guide frames may be disposed to extend in a vertical width direction of the front bumper to be parallel to each other, and each of the guide holes may be formed in a slot shape having a predetermined width and a predetermined length.

The skirt may include coupling bosses to be inserted into the guide holes.

The coupling bosses may include a pair of first coupling bosses and a pair of second coupling bosses which protrude in both side directions from a rear surface of the skirt.

The first coupling bosses may be positioned on an upper portion of the skirt, and the second coupling bosses may be positioned at a lower level than the first coupling bosses.

### BRIEF DESCRIPTION OF THE DRAWINGS

FIG. 1 is a schematic view illustrating an operating state in which a skirt protrudes downward from a front bumper on which a vehicle active air skirt is installed;

FIG. 2 is a schematic perspective view illustrating a vehicle active air skirt according to an embodiment of the present invention;

FIG. 3 is a schematic side view illustrating the vehicle active air skirt of FIG. 2;

FIG. 4 is a schematic exploded perspective view illustrating the vehicle active air skirt of FIG. 2; and

FIGS. 5 to 9 are schematic views illustrating variable states of the skirt according to rotation angles of a loader.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION OF EXEMPLARY EMBODIMENTS

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Hereinafter, embodiments will be described in detail with reference to the accompanying drawings, but the same or corresponding components are assigned the same reference numbers even in different drawings and are not redundantly described herein.

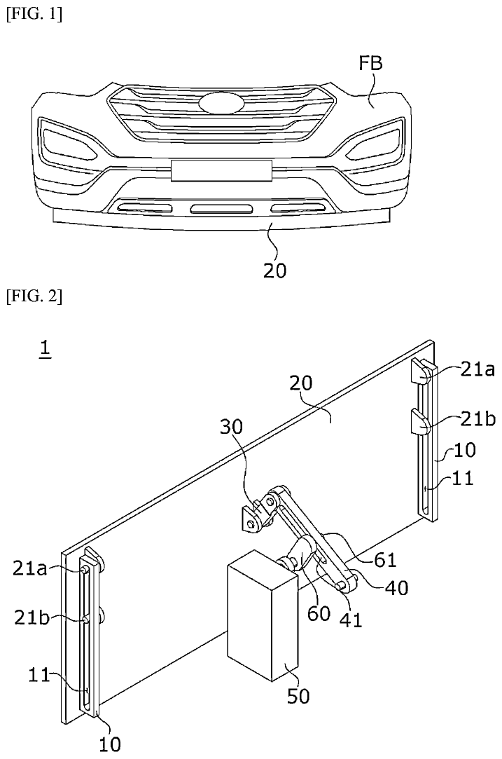

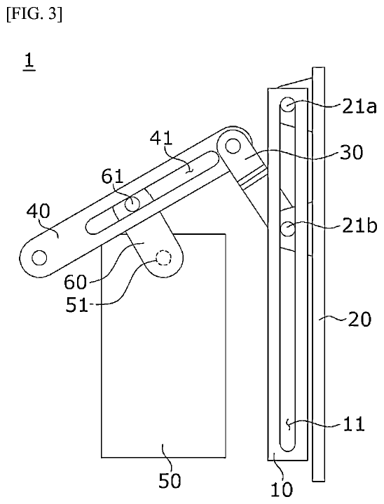

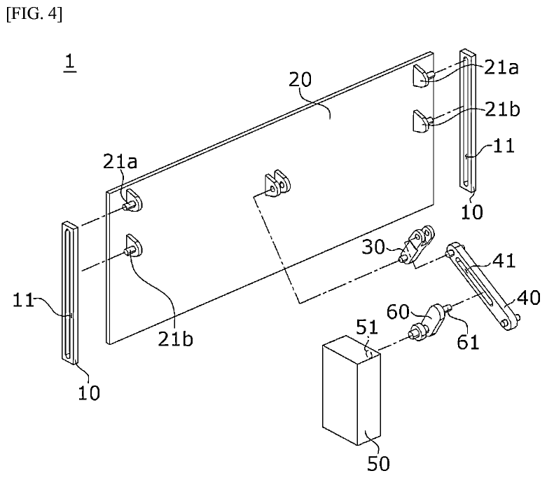

FIG. 1 is a schematic view illustrating an operating state in which a skirt protrudes downward from a front bumper on which a vehicle active air skirt is installed, and FIG. 2 is a schematic perspective view illustrating a vehicle active air skirt according to an embodiment of the present invention. FIG. 3 is a schematic side view illustrating the vehicle active air skirt of FIG. 2, and FIG. 4 is a schematic exploded perspective view illustrating the vehicle active air skirt of FIG. 2.

A vehicle active air skirt 1 according to the embodiment of the present invention may be installed to be covered by a front bumper FB of a vehicle so as not to be exposed to the outside.

Referring to the drawings, the vehicle active air skirt 1 may include a guide frame 10, a skirt 20, a first link 30, a second link 40, an actuator 50, and a loader 60.

The guide frame 10 may be fixedly installed inside the front bumper FB. However, the guide frame 10 may also be installed on a vehicle body inside the front bumper FB.

The guide frame 10 is provided as a pair of guide frames 10, and the pair of guide frames 10 may be disposed in parallel on both left and right sides of the front bumper FB to face each other. In this case, the guide frame 10 may be provided to extend in a vertical width direction of the front bumper FB.

The guide frames 10 may include guide holes 11. Each of the guide holes 11 may be formed in a slot shape having a predetermined width and a predetermined length in a longitudinal direction of the guide frame 10.

The skirt 20 may be connected to the guide holes 11 inside of the front bumper FB and disposed to be supported by the guide frames 10. The skirt 20 may be formed in a substantially quadrangular shape extending in a longitudinal left-right direction of the front bumper FB.

The skirt 20 may include coupling bosses 21 inserted into and coupled to the guide holes 11.

The coupling bosses 21 may include a pair of first coupling bosses 21a and a pair of second coupling bosses 21b which protrude from a rear surface of the skirt 20 in both side directions. The first coupling bosses 21a and the second coupling bosses 21b may be disposed to face the guide holes 11 of the guide frames 10 in left and right regions of the skirt 20, respectively.

The first coupling bosses 21a may be positioned on an upper portion of the skirt 20, and the second coupling bosses 21b may be positioned at a lower level than the first coupling bosses 21a. That is, the first coupling bosses 21a and the second coupling bosses 21b may be disposed in parallel to be spaced apart from each other in the left and right regions of the skirt 20, respectively.

The skirt 20 may slide vertically along a trajectory provided by the guide holes 11 in a state in which the first coupling bosses 21a and the second coupling bosses 21b are inserted into the guide holes 11.

In addition, the skirt 20 may vary between a stored state in which the skirt 20 moves upward along the guide holes 11 and is stored inside the front bumper FB and an operating state in which the skirt 20 moves downward along the guide holes 11 and protrudes downward from the front bumper FB.

The actuator 50 may provide power so that the skirt 20 enters the stored state or the operating state, and the first link 30 and the second link 40 may transmit the power of the actuator 50 to the skirt 20.

In the embodiment, a direct current (DC) motor of which power consumption and a cost are low may be used for the actuator 50. In particular, even when the actuator 50 rotates in one direction, the stored state and the operating state of the skirt 20 may be implemented (FIGS. 4 to 8). However, according to an embodiment, an alternating current (AC) motor or brushless DC (BLDC) motor which rotates in two directions may also be used for the actuator 50, and the actuator 50 is not limited thereto.

One end of the first link 30 may be rotatably connected to a rear surface of the skirt 20. The other end of the first link 30 may be rotatably connected to one end of the second link 40. In addition, the other end of the second link 40 may be rotatably connected to the vehicle body. Accordingly, the skirt 20 may vertically reciprocate along the trajectory provided by the guide holes 11 in conjunction with the first link 30 as the second link 40 rotates around the other end of the second link 40 as a rotation shaft.

In the embodiment, the first link 30 and the second link 40 may form a rotatable connecting structure using hinge connection.

The first link 30 and the second link 40 may be formed to have different lengths. For example, the length of the second link 40 may be greater than the length of the first link 30.

The second link 40 may include a connecting hole 41 extending in a longitudinal direction. The connecting hole 41 may be formed in a slot shape passing through the second link 40.

The actuator 50 may rotate the second link 40.

As illustrated in the drawings, the actuator 50 and the second link 40 may be connected from each other through the loader 60.

One end of the loader 60 may be connected to a driving shaft of the actuator 50, and the other end thereof may pass through and be connected to the second link 40 so that the power of the actuator 50 may be transmitted to the second link 40. That is, the power of the actuator 50 is not transmitted directly to the second link 40 but is transmitted to the second link 40 through the loader 60.

The second link 40 may have a structure of which the length is longer than a length of the loader 60.

The other end of the loader 60 connected to the second link 40 may include a connecting protrusion 61 inserted into the connecting hole 41. In addition, the power of the actuator 50 may be transmitted to the second link 40 in a state in which the connecting protrusion 61 is inserted into and connected to the connecting hole 41.

Specifically, the loader 60 rotates around the driving shaft such that the connecting protrusion 61 slides along the connecting groove 41. Accordingly, the second link 40 rotates around the other end of the second link 40 as the rotation shaft along a rotation trajectory provided by the connecting protrusion 61 in a state in which the connecting protrusion 61 is engaged with the connecting hole 41. In addition, one opposite end of the second link 40 vertically reciprocates between the guide frames 10. A rotation speed of the second link 40 may be variously controlled by adjusting the length of the loader 60.

In the embodiment, a circumferential length of a circle drawn while the connecting protrusion 61 rotates around the driving shaft may be two times a length of the connecting hole 41. That is, the connecting protrusion 61 may reciprocate once along the connecting hole 41 when rotating once around the driving shaft. In addition, the skirt 20 may be changed to the operating state from the stored state, and then returned to the stored state.

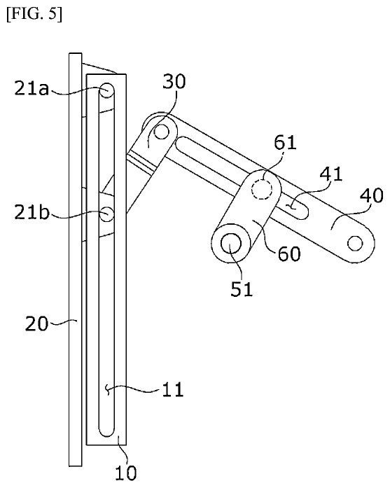

Referring to FIGS. 5 to 9, a process in which rotational movement of the first link 30 and the second link 40 changes the skirt 20 into the stored state and the operating state will be described.

FIGS. 5 to 9 are views illustrating variable states of the skirt 20 according to rotation angles of the loader 60.

As illustrated in FIG. 5, when there is a bump or obstacle on a road, the skirt 20 is disposed in the stored state when the vehicle is stopped or travels at low speed to prevent damage thereto.

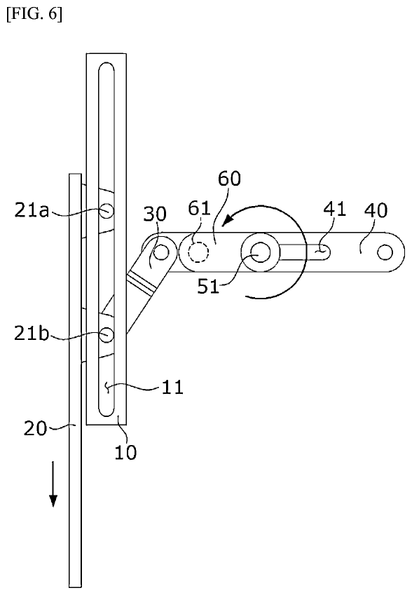

As illustrated in FIG. 6, in an intermediate operating state, when the loader 60 is rotated at a set angle, approximately 120°, by driving of the actuator 50, and accordingly, the second link 40 is rotated to move one end of the second link 40 in a downward direction of the skirt 20, the first link 30 connected to the second link 40 is also rotated downward to move the skirt 20 downward. Accordingly, the skirt 20 maintains a state in which the skirt 20 partially protrudes downward from the front bumper FB.

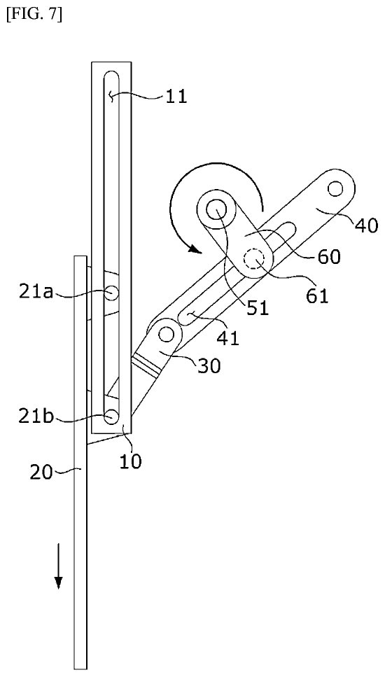

As illustrated in FIG. 7, in a full operating state, the loader 60 is rotated at a set angle, approximately 240°, by driving of the actuator 50, and accordingly, the second link 40 is rotated so that, when one end of the second link 40 moves in the downward direction of the skirt 20, the first link 30 connected to the second link 40 is also rotated downward to move the skirt 20 downward. Accordingly, the skirt 20 maintains a state in which the skirt 20 fully protrudes downward from the front bumper FB. As described above, when the vehicle travels at high speed, the skirt 20 operates in the full operating state, an amount of air flowing into an undercover of the vehicle is reduced, and thus aerodynamic performance can be improved.

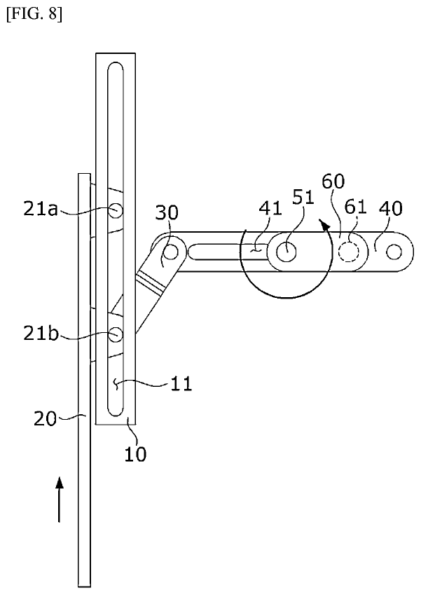

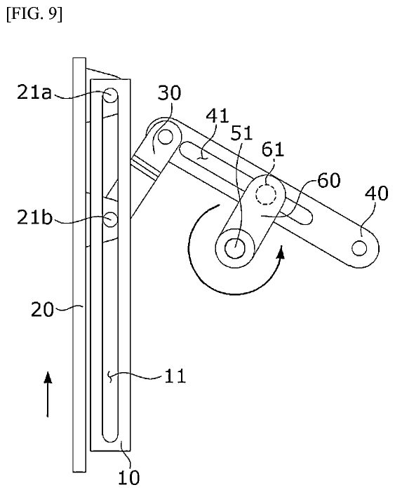

In addition, as illustrated in FIGS. 8 and 9, when the loader 60 is rotated at 300° and 360° by driving of the actuator 50, one end of the second link 40 is moved again in an upward upper direction of the skirt 20 to rotate the first link 30 upward, and accordingly, the skirt 20 is also moved upward. Accordingly, the skirt 20 may be changed into the intermediate operating state in which the skirt 20 protrudes partially and into the stored state in which the skirt 20 is stored.

As described above, according to the present embodiment, as the skirt 20 operates more simply through a hinge connecting structure of the first link 30 and the second link 40, the number of components can be minimized, and an overall connecting structure can be simplified. Accordingly, there are advantages in securing assemblability and mass productivity.

In addition, as the power of the actuator 50 is transmitted to the second link 40 through the loader 60, a rotation speed of the second link 40 can be more easily controlled.

According to an embodiment of the present invention, a vehicle active air skirt with a structure capable of reducing the number of components and simplifying a connecting structure can be provided.

Effects of the present invention are not limited to the above-described effects, and other effects which are not describe will be clearly understood by those skilled in the art from the description of the claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A vehicle active air skirt comprising:
a pair of guide frames including guide holes and installed inside a front bumper;
a skirt connected to the guide holes inside the front bumper and supported by the guide frames;
a first link of which one end is rotatably connected to a rear surface of the skirt;
a second link of which one end is rotatably connected to the other end of the first link and the other end is connected to a vehicle body; and
an actuator configured to rotate the second link,
wherein the skirt is configured to reciprocate upwardly and downwardly along a trajectory provided by the guide holes as the second link rotates around the other end of the second link as a rotation shaft.

2. The vehicle active air skirt of claim 1, further comprising a loader which connects the actuator and the second link,
wherein one end of the loader is connected to a driving shaft of the actuator, and
the other end of the loader passes through and is connected to the second link to transmit power of the actuator to the second link.

3. The vehicle active air skirt of claim 2, wherein:
the second link includes a connecting hole extending in a longitudinal direction of the second link,
the other end of the loader includes a connecting protrusion to be inserted into the connecting hole, and
the loader rotates around the driving shaft such that the connecting protrusion slides along the connecting hole.

4. The vehicle active air skirt of claim 3, wherein the one end of the second link vertically reciprocates between the guide frames as the second link rotates around the other end of the second link as the rotation shaft in a state in which the connecting protrusion is engaged with the connecting hole.

5. The vehicle active air skirt of claim 3, wherein a circumferential length of a circle drawn while the connecting protrusion rotates around the driving shaft is two times a length of the connecting hole.

6. The vehicle active air skirt of claim 2, wherein a length of the second link is greater than a length of the loader.

7. The vehicle active air skirt of claim 1, wherein:
the guide frames are disposed to extend in a vertical width direction of the front bumper to be parallel to each other; and
each of the guide holes has a slot shape having a predetermined width and a predetermined length.

8. The vehicle active air skirt of claim 1, wherein the skirt includes coupling bosses to be inserted into the guide holes.

9. The vehicle active air skirt of claim 8, wherein the coupling bosses include a pair of first coupling bosses and a pair of second coupling bosses which protrude in both side directions from a rear surface of the skirt.

10. The vehicle active air skirt of claim 9, wherein:
the first coupling bosses are positioned on an upper portion of the skirt; and
the second coupling bosses are positioned at a lower level than the first coupling bosses.
